(19) United States
(12) Patent Application Publication
(10) Pub. No.: US 2003/0182573 A1
(43) Pub. Date: Sep. 25, 2003

(54) Content filtering and management

(76) Inventors: Steve John Toneguzzo, New South Wales (AU); Aftab Ahsan Rizvi, New South Wales (AU)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/070,491

(22) PCT Filed: Jul. 9, 2001
(86) PCT No.: PCT/AU01/00823

(30) Foreign Application Priority Data
Jul. 7, 2000 (AU) PQ 8657

(51) Int. Cl. H04L 9/00

(52) U.S. Cl. 713/201

(57) ABSTRACT

The invention provides methods and apparatus for implementing Internet content filtering based on a classification system. The classification system is promulgated by a Certification Authority in furtherance of a public policy objective. The bona fides of the system are upheld and the system is implemented through the issuance of digital certificates and electronic compliance seals.

### TECHNICAL FIELD

The invention pertains to on-line content filtering and more particularly to methods, apparatus and software for content filtering which uses a rating system in combination with a digital certificate to thwart abuse, instil public confidence and assist in the management of the system.

### BACKGROUND ART

Content filtering is a measure to implement a public policy for the protection of on-line users, for example Internet users. The implementation of a filtering scheme therefore carries a number of security risks. The main risks are:

that an unauthorised or unintended recipient will intercept a transmission and read or use its contents

that a provider will attempt to avoid responsibility for their content by making available content under someone else's certificate

that a provider will abusively change the available content

that a provider will deny providing particular content,

In the traditional mail system, a signature, letterhead paper, and a sealed envelope addresses these concerns. To provide these services electronically, a technique called public key cryptography is used. These cryptographic techniques are used within a Public Key Infrastructure (PKI), a PKI is a system that provides the basis for establishing and maintaining a trustworthy networking environment through the generation and distribution of keys and certificates.

To encrypt is to apply a mathematical function that transforms every character in the file into some other character. Encryption renders a file unreadable.

Cryptography enhances security by encrypting a file, data, transmission or message using a secret key in association with an algorithm. This produces a ‘scrambled’ version of the message that the recipient can decrypt, using the original key, to retrieve the contents. The key used must be kept secret between the two parties.

Public key cryptography replaces the secret key with a pair of keys, one private and one public. Information encrypted using the public key can only be retrieved using the complementary private key. In addition to encryption, the public and private keys can be used to create and verify an identity for example ‘digital certificates’. These can be appended to content to uniquely identify the provider and the nature of the content.

### DISCLOSURE OF THE INVENTION

The present invention provides and facilitates a scheme in which content is filtered according to whether or not content pages include a proprietary digital certificate. The digital certificate required to pass the filtering is issued by a body which applies certain criteria to on-line resources and which assigns to each resource, site or page a classification or promotes a system of self-classification.

Filtering is preferably accomplished at the ISP level by applying the certificate to a public key. Each classification has a common public key. The digital certificates issued by the body include the body's key and additional layers of cryptographic protection based on features such as the classification, domain, URL expiry date or a random number.

The present invention requires that on-line content be filtered so that an acceptable percentage of undesirable content fails to reach on-line users.

It is preferred that content be classified according to socially acceptable norms. Thus, a body is convened, which establishes with respect to content individual domains, sites or URLs (“resources”) a classification. Classifications might include PG, G, M and R similar to the classifications utilised by the motion picture industry. Other classifications may be used as well.

### MODES FOR CARRYING OUT THE INVENTION

With regard to Internet content filtering, public key cryptography, on its own, is not enough to implement an effective filtering regime in furtherance of public policy. Also needed are (a) security policies to define the rules under which the cryptographic systems should operate, (b) hardware and software products to generate, store and manage the keys, and (c) procedures to dictate how the keys and certificates should be generated, distributed and used.

A Public Key Infrastructure (PKI) provides the core framework for components, applications, policies and practices to address the main security risks.

A Public Key Infrastructure is a combination of hardware and software products, policies and procedures. PKI is based on digital IDs known as ‘digital certificates’ which act like ‘electronic passports’.

A typical PKI should consist of:

A security policy for establishing top-level security, as well as the processes and principles for the use of cryptography. It is essentially the rules by which an administering organisation will handle keys and valuable information.

Certificate Practice Statement (CPS) This is a document defining the operational procedures on how the security policy will be enforced and supported in practice, how certificates are issued, accepted and revoked, and how keys will be generated, registered and certified, where they will be stored, and how they will be made available to users.

Certificate Authority (CA) The CA system is the trust basis of a PKI as it manages public key certificates for their whole life cycle. The CA issues certificates by binding the identity of a user or system to a public key with a digital signature. The CA establishes the schedule of expiry dates for certificates and ensures certificates are revoked when necessary by publishing Certificate Revocation Lists (CRLs). When implementing a PKI, an organisation can either operate its own CA system, or use the CA service of a Commercial CA or Trusted Third Party.

Registration Authority (RA) An RA provides an optional intermediary between the user and the CA. It captures and authenticates the identity of the users and submits the certificate request to the CA.

Certificate Distribution System

PKI-enabled Applications. A PKI is a means to an end, providing the security framework by which PKI-enabled applications can be confidently deployed to achieve the end benefits, in this case the implementation of public policy by moderating the content received by users, for example on-line web servers to browsers.

The present invention proposes a specially configured Digital Certificate that allows the verification (at the ISP, intermediate, browser level and end user level) of the proposition that a person or business has the right to use a given rating and therefore a given key. The certificate prevents impersonation, the use of phoney keys. As previously mentioned, digital Certificates are based on the use of public and private key pairs. A specially constituted Digital Certificate according to the present invention may contain, the content name, an expiration date, the name of the Certification Authority that issued the Digital Certificate, a serial number, a random number and perhaps some other information based on URL, domain, a classification promulgated by the CA or a description.

The proposed Digital Certificate may optionally be used in connection with other cryptography methods such as digital signatures, for example for maintaining user privacy. A digital signature is like a paper signature, except that it is fully electronic. An effective digital signature is more secure than a paper signature. A digital signature provides a guarantee to a recipient that the signed file came from the person who sent it, and that it was not altered since it was signed.

To create a digital signature, the information sender creates a “hash”, unique shortened version of the transmission or message, and then uses his private key to encrypt the hash. The encrypted hash is the digital signature. If the message is changed in any way, the hash result of the changed message would be different.

The digital signature is unique to both the message and the private key used to create it, so it cannot be forged. The digital signature is then appended to the message and both are sent to the message recipient.

The recipient reconstitutes the hash from the received message, then uses the public key of the original sender to decrypt the hash included in the received message.

If the two hash results are identical the digital signature was created using the signer's private key. This serves as assurance that the public key corresponds to the signer's private key. This also confirms that no one is pretending to be or masquerading as the signer. This also substantiates (a) the authenticity of the signer, (b) that the signer cannot claim to have not signed the message, and (c) that the message has not been changed.

In the United States, The Electronic Signatures in Global and National Commerce Act, S 761, commonly known as the “e-Sign Bill”, is expected to make digitally-signed electronic transactions legally binding, the same way paper documents with handwritten signatures are binding today. The US Senate passed the bill unanimously by a vote of 87-0. This trend is seen as a global one.

Security Policy

The basic tenant by which the public policy mandate is executed is that users shall be denied access to content that is not certified (“reverse filtering”) by the CA (“reverse filtering”) or that is certified by the CA but does not match specific criteria (“criteria filtering”). Implementation of the filtering off of uncertified resources preferably occurs at the ASP or ISP level but may be implemented at another level (e.g. the browser) or by a combination. The essence of reverse filtering is to provide a viable means of content filtering and regulation of Internet content by not imposing significant processing overhead.

The certificate is generated as follows:

1. The inputs may include: applicant's domain name, logical address, country of origin, URL, encryption key, public key of CA, classification, official descriptor, other data.

2. The inputs are manipulated through an algorithm to produce an identification number.

3. The CA identifier (assigned by the root CA) and the CA's URL is appended to the identification number to form a globally unique certificate.

4. The certificate is associated with a compliance seal. The compliance seal may be available (visual, mechanical, audible) on the browser or on the resource. Associated with the availability of the compliance seal is a link to the issuing CA (for example this link will take the user to the home page of the CA from which complaints may be lodged, the CPS may be available, etc).

In addition to generally accepted security guidelines (e.g. Guidelines issued by Defence Signals Directorate, Australia), special security arrangements should be made to secure public/private key pair for CA, resources (hardware and software) involved in the production and delivery of the compliance certificate. Strong encryption would be implied in delivering the compliance certificate from the CA to the provider. Physical and logical security of the filtering software at the ISP sites is imperative.

Certificate Practice Statement

This document (CPS) will be publicly available.

The CPS document will consist of, but is not limited to, procedures for the following:

I. PKI Infrastructure.

II. Organisational relationships.

III. Public policy and legislative matters.

IV. RA and CA standard operating internal controls and procedures.

V. Definition of classification and related criteria.

VI. Security classifications.

VII. Codes of conduct.

VIII. Fees and charges.

IX. List of acceptable bona-fides for all stakeholders.

X. Application for certificate.

XI. Self-assessment.

XII. Auditing prior to application.

XIII. Ongoing auditing.

XIV. Terms and conditions.

XV. Generation and security of digital certificate.

XVI. Generation and security of compliance seal.

XVII. Rules of use.

XVIII. Delivery of digital certificate and seal.

XIX. Revocation of digital certificate and seal.

XX. Distribution and usage of revocation and attribute tables.

XXI. Frequently asked questions.

XXII. User help.

XXIII. Complaints mechanisms.

XXIV. Metrics and statistical analysis.

XXV. Distribution, installation, operation and security of applications, filtering software and hardware.

XXVI. General information.

XXVII. Enforcement mechanisms and penalties.

XXVIII. Any other applicable information.

Certificate Authority

Importantly, the CA establishes the schedule of expiry dates for certificates and ensures certificates are revoked when necessary by publishing Certificate Revocation Lists (CRLs). In some preferred embodiments of the invention certificates issued by the CA, the RA or its subordinates expire frequently so as to thwart abuse and instil public confidence. It is preferred to automatically update both the key and certificate before key expiry. Automatic key update provides strong security since it ensures that keys are only used for a specific time period. Automatic renewal of certificates may depend upon, for example, the classification, content providers track record, complaints against the provider, audit results, etc. In the scheme of the present invention, the CURL is published to the participating ISPs that use it for filtering. A CURL may be unnecessary if the lifetime of the certificate is short.

The CA maintains a management policy and determines whether the CA key is stored on specialised hardware, the particular algorithm used to encrypt the CA signing key, and how often the CA updates its list of users whose certificates have been revoked.

The CA may also administer the process of adding subordinate CAs to a hierarchy of CAs if multiple CAs are needed and where one root CA must control all other CAs.

Registration Authority

An RA intermediary can relieve the administrative burden on the CA and provide a politically neutral, commercial level of customer service and technical proficiency.

Certificate Distribution System

Certificates are distributed upon application by an interested party. The application is reviewed according to the CPS. The applicant may be assigned one or more ratings according to the categories established by the CA. If the automated or manual evaluation of the applicant's bona fides and proposed content is acceptable, they are issued with a certificate for each resource e.g. URL covered by their application to the CA. The issued certificate carries the private key and each category is associated with its own public key which is provided to participating ISPs. The issued certificate may also include additional security layers associated with the category, official description, URL, domain or a random number. It is preferred that certificates be renewed automatically and frequently and that the CA have the authority to deny the renewal if the terms of the CPS are violated.

The certificate can be delivered using the following mechanisms:

1/. Secure e-mail.

2/. Download from a secure website after obtaining an encryption key from the CA.

3/. Physical delivery.

4/. Vending machine.

5/. Other methods.

The certificate is appended to all resources of a given classification at a given site. This therefore implies that if resources of varying classifications apply at one site, that site may obtain more than one certificate to permit access. There are a number of options for appending the certificate either at the page level or the individual resource level:

1/. Using an automated script supplied by the CA.

2/. Following a manual process of embedding the certificate in the code.

3/. Using software tools.

4/. Other methods.

PKI-Enabled Applications

For the PKI to function, the participating ISPs must be provided with software which supports the CPS. The CPS is supported by filtering content from the on-line transmission to the user which lacks a valid certificate. A transmission which lacks a certificate or is accompanied by a fake or expired certificate is excluded from the traffic from the ISP to the user. For this to occur the ISP may have to cache a complete resource including its certificate before transmission to a user occurs.

In some embodiments, the validity of the certificate is denied if the certificate is determined to not cover a particular classification. For example a browser, browser plug in, or other client application provided to users may allow a user to request that only certain categories be transmitted to them and the ISP's software compares the user's request to the incoming certificate as part of a filtering process. Alternately the ISP can implement CPS policy or directives, for example by filtering all content which is both of a particular rating rated and is from selected domains from being transmitted to other selected domains in a particular country at certain times.

In other embodiments the ISP can filter according to the published CURL where the renewal interval of the issued certificates is long enough to warrant additional measures to prevent reported or detected abuse of the CPS.

It may also be advantageous to provide a mechanism for informing users that the content they display or otherwise use is in compliance. This may be done by including a compliance seal or evidence of it in the content display, for example, as an image which is displayed in a browser display area. In the alternative, a certain area of the browser control panel or area is set aside for a representation of the compliance certificate. It is preferably the graphical image which functions as a hyperlink. In the alternative an auditory or mechanical indication may be used in place of a graphical image or button. The representation of the compliance certificate is an indicator and will vary depending on the classification and or the official descriptor or other criteria. Therefore the appearance of the graphical image may change as the URL changes as may the hyperlink which the image represents if the CA changes from one URL to another.

The Compliance Seal is distributed under licence and the use is tied to continuing compliance.

In certain cases, the compliance certificate may be invalidated if the site is modified without application for assessment to the CA. This may be accomplished by embedding a digital signature in the digital compliance certificate. In the alternative, a digital certificate may separately accompany a resource to allow verification that the contents have not changed without the CA's authority.

In other embodiments and through a mechanism either at the ISP, or intermediatory device (e.g. corporate network filtering), or the end user device (e.g. Browser), the authenticated content may be further filtered based on the classification and other information embedded in the certificate. That is, instead of using existing filtering techniques whereby all content is filtered for keywords, or other attributes, filtering of content is conducted exclusively on a the basis of the rating, and/or other certificate information. This end user filtering may be added to firewall or router software or the browser, or be a separate application that “sits” in front of the browser.

For example, the browser may be configured to only allow “G” rated material through. If a search is done on “sex” all authorised sites with a “G” to “R” rating may be passed from the ISP to the end user. However, the end user filter will block all content that is not “G” rated.

Hence there are essentially two “exclusion filtering” products: An ISP, ASP, (or similar) Digital Certificate exclusion filter (DEF) and an end user classification exclusion filter (U-CEF). The two may be combined.

In the case of the U-CEF, this filter may also incorporate filter tables applicable to each classification. These filter tables may be used to “auto-audit” for known key attributes of un-classified content. The attributes may be compiled from a database of common complaints and as such provide some level of ongoing assurance that a certain classification is valid. In the event that a breach is detected, the CA may be notified via an e-mail or other mechanism to investigate the content.

Furthermore, the U-CEF as a stand-alone application, or as a function of a browser, may be configured to issue a cookie, or file with a search or delivery request from an end-user. In this instance the classification filtering may occur at the ISP, or indeed at the host site. For example, the host site may be provided with an application that establishes permissions on content and only allows access to content based on the classification permissions from the user request.

### EXAMPLES

A provider of online content seeking a certificate applies to either the CA or RA for a certificate. This may be at the time of Domain name registration, renewal, or upon separate and perhaps unrelated electronic or in-person application. In applying for the certificate, the applicant must understand the classification of service being requested. The application includes the details required to identify the applicant and also includes a self-assessment. An element of the processing includes establishing the bona-fides of the applicant. A statement must be provided by the applicant which demonstrates compliance with the criteria associated with a classification.

In relation to the applicant statement and ongoing compliance (feedback through complaints mechanism or auditing), it is envisaged that there would be penalties and legal remedies for a breach of the code or misuse of a compliance seal. These may include:

1/. Legislative penalty.

2/. Banning the site by inclusion on a blacklist until the certificate expired.

3/. Ongoing, frequent audits at the provider's expense.

4/. Infringement of Trade-Mark.

5/. Infringement of Copyright.

6/. Patent infringement.

7/. Non-renewal of certificate.

8/. Other methods.

### Example 1

Self Assessment:

The application is processed and at that time the application is either audited or not and a certificate is generated. A random criteria or specific matching with nominated attributes may be adopted for determining if an audit is required before issuing of the certificate. However, a team of auditors or an automated auditing tool will be auditing sites on an ongoing basis by specific or random selection.

### Example 2

Audit:

Based on a classification or category within a classification, auditing of the application may be mandatory. For example, an on-line gambling site may be required to provide evidence of a licence and the site and content approved as complying with a set of government criteria. In the extreme alternative, all content of every web page or every file available at an ftp site, may be required to have its contents audited.

### Example 3

Definition of Modification Induced Expiry:

At the time of auditing an application is installed at the site which identifies certain files or data, takes an input or seed, runs the seed through a secure algorithm associated with that data and produces a signature of that data. Provided the seed and the data remain constant, the signature will remain constant. The data check may be initiated at the hosting site or remotely from the CA or RA. The certificate may or may not be dynamic in nature whereby a modification to the site signature may result in a modification to the digital certificate and thereby render the certificate invalid or expired. In such instances the provider will be required to apply to the CA whenever content nominated by the auditor is intended to be modified. The CPS will define exceptions in the event of emergency patches or the like. An example of a site where this might be applied is that of an online gambling site.

1. A digital compliance seal comprising:
an indicator or an instruction to indicate, which indication or instruction is transmissible to an Internet user;
the seal being indicative of a classification of an Internet resource and transmissible in conjunction with a digital certificate;
the certificate having as an input, the classification.

2. The seal of claim 1, wherein:
the seal is a graphical image which is also a hyperlink or button style link.

3. The seal of claim 1, wherein:
a digital signature is embedded in the digital certificate.

4. In a method of generating a digital certificate, the improvement comprising:
utilising a classification of an Internet resource as an input;
the classification furthering a public policy.

5. Software for an Internet browser, comprising:
computer readable code for generating a user interface;
codes for generating an indicator, such as a visual or audible indicator, on a user's PC, when a digital certificate associated with an Internet resource and received by the browser, corresponds to a classification which the user has programmed the browser to accept; and
code for blocking an Internet resource when it is not associated with a digital certificate, or when the digital certificate does not correspond to the classification.

6. The software of claim 5, wherein:
the user interface is adapted to display a predetermined graphical image which corresponds to a classification, when the certificate corresponds to that classification.

7. The software of claim 6, wherein:
the graphical image is a link.

8. The software of claim 7, wherein:
the link is a link to a CA or RA.

9. A method of operating an ISP, comprising the steps of:
running software for receiving digital certificates which are associated with Internet resources which have been requested by a user of the ISP;
the digital certificate carrying a classification within a classification regime promulgated by a CA;
receiving from a user, instructions as to which classifications the user wishes to receive;
comparing the user instructions to the classification carried by the digital certificate; and
forwarding the resource to the user only if the comparison is favourable.

10. A method of publishing Internet content, comprising the steps of:
applying a classification system to an Internet resource and thereby arriving at a classification for that resource;
transmitting a digital seal of compliance or a flag for a seal of compliance as part of that resource, the seal or flag being indicative of the classifications;
associating the seal or flag with a digital certificate which is issued by a CA which implements the classification system, the certificate having the classification as an input; and
transmitting the certificate in conjunction with the seal or flag.
